(19) United States
(12) Patent Application Publication
(10) Pub. No.: US 2010/0064261 A1
(43) Pub. Date: Mar. 11, 2010

(54) PORTABLE ELECTRONIC DEVICE WITH RELATIVE GESTURE RECOGNITION MODE

(75) Inventors: Anton Andrews, Seattle, WA (US); Thamer Abanami, Seattle, WA (US); Jeffrey Fong, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/206,747

(22) Filed: Sep. 9, 2008

(51) Int. Cl. G06F 3/033

(52) U.S. Cl. 715/863

(57) ABSTRACT

A computer program executable on a portable electronic device having a touch screen sensor is provided. The computer program may include an input mode switching module configured to receive a mode switch user input to switch between a direct input mode and a relative gesture recognition mode. The computer program may further include a gesture-based control module configured, in the relative gesture recognition mode, to recognize a contact point on the touch screen sensor between a digit of a user and a surface of the touch screen sensor in a defined region in which the graphical user interface elements are unselectable, and to identify a detected gesture based on user touch input originating from the contact point, and to send a message to an application program to adjust an operation of the portable electronic device based on the detected gesture.

### BACKGROUND

Portable electronic devices equipped with touch screens enable users to directly interact with graphical user interface elements displayed on the screen via touch input sensed by a touch screen sensor. The user visually examines the screen, and touches the screen in a location at which a graphical user interface element is displayed. The touch input is sensed by the device as occurring at the location of the graphical user interface element, triggering appropriate functionality on the portable electronic device.

One drawback with such devices is that they are difficult to interact with when the user cannot, or prefers not to, visually examine the screen. For example, when a user is exercising, riding a subway train, etc., the user may find it inconvenient or undesirable to look at the screen for extended periods of time. This may result in input errors by the user, or cause the user to look at the screen during at an undesirable time, generally frustrating the user experience.

### SUMMARY

An computer program executable on a portable electronic device having a touch screen sensor is provided. The computer program may include an input mode switching module configured to receive a mode switch user input to switch between a direct input mode and a relative gesture recognition mode in response to a user input. In the direct input mode, one or more graphical user interface elements of a graphical user interface of the portable electronic device are selectable via touch input of the user. In the relative gesture recognition mode, the graphical user interface elements in at least a defined region of the graphical user interface are made to be unselectable. The computer program may further include a gesture-based control module configured, in the relative gesture recognition mode, to recognize a contact point on the touch screen sensor between a digit of a user and a surface of the touch screen sensor in the defined region in which the graphical user interface elements are unselectable, and to present in the defined region a gesture control proximate to the contact point. The gesture-based control module may further be configured to identify a detected gesture based on user touch input originating from the contact point, and to send a message to an application program to adjust an operation of the portable electronic device based on the detected gesture.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of one embodiment of a computing device having a display equipped with a touch screen sensor, and being configured to execute an computer program to switch between a direct input mode and a relative gesture recognition mode.

FIG. 2 illustrates a transport control in the relative gesture recognition mode, for use with a media playback application program on the portable electronic device of FIG. 1.

FIG. 3 illustrates a virtual game control in the relative gesture recognition mode, for use with a computer game application program on the portable electronic device of FIG. 1.

FIG. 4 illustrates a method of controlling a portable electronic device having a touch screen sensor.

### DETAILED DESCRIPTION

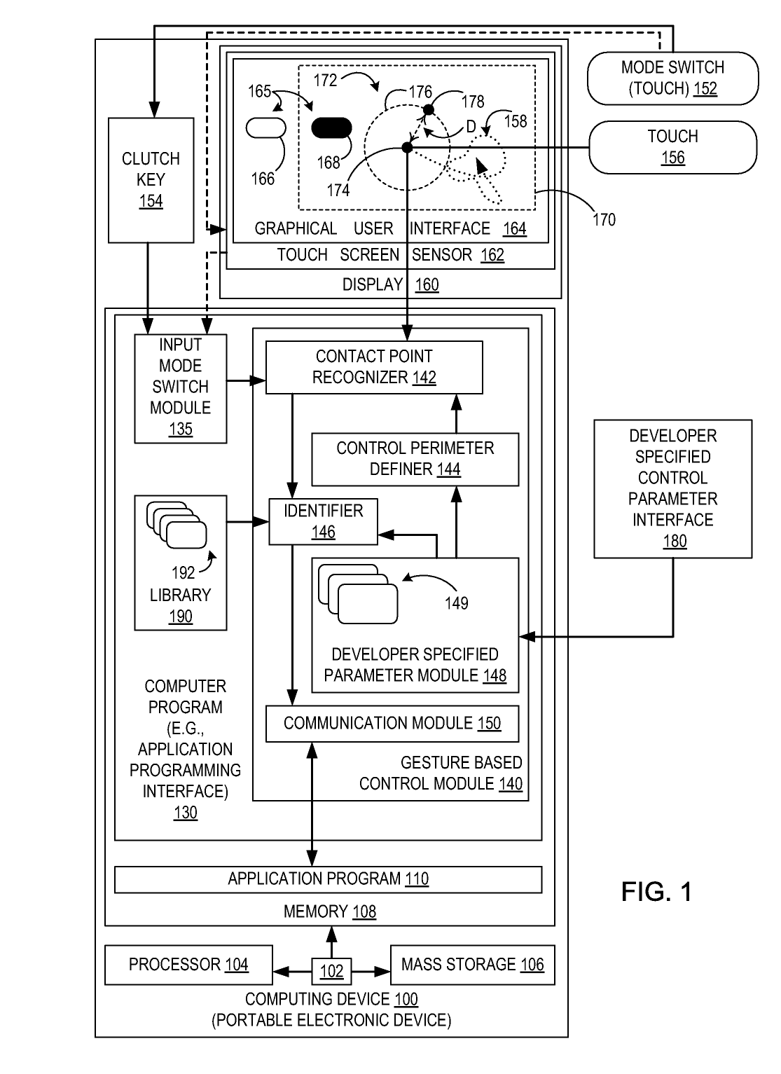

FIG. 1 illustrates a computing device which, for example, may be a portable electronic device 100 such as a portable media player or a web-enabled mobile telephone. Portable electronic device 100 includes a processor 104 which is in electronic communication with memory 108 and mass storage 106 via a communication bus 102, and is configured to execute one or more application programs 110 using portions of memory 108. Portable electronic device 100 further includes a display 160 having a touch screen sensor 162. Display 160 may present a graphical user interface 164 having one or more graphical user interface elements 165.

The graphical user interface 164 may be configured with a direct input mode in which one or more graphical user interface elements 165 of the graphical user interface are selectable graphical user interface elements 166, which are selectable via touch input of the user sensed by the touch screen sensor 162 at a location of the selectable graphical user interface element 166 on the display 160. Examples of selectable graphical user interface elements 166 include buttons, sliders, scroll bars, hyperlinks, pull down menus, icons, etc. The behavior of these various selectable graphic user interface elements 166 may be programmed, for example, via a computer program 130, which may be an application programming interface. Thus, in response to a user touch input selecting a selectable graphical user interface element 166, the portable electronic device may exhibit a programmed behavior associated with the selectable graphical user interface element 166, such as selecting a pull down menu option, scrolling a window, etc.

To enable a user to switch input modes, portable electronic device 100 may include a computer program 130, such as an application programming interface, which includes an input mode switch module 135 configured to receive mode switch user input 152 to switch between the direct input mode and a relative gesture recognition mode in response to mode switch user input 152. In the relative gesture recognition mode, one or more graphical user interface elements 165 in at least a defined region 170 of the graphical user interface 164 are made to be unselectable graphical user interface elements 168. In other words, an input received at a location adjacent a particular unselectable graphical user interface element 168 in the relative gesture input mode will not cause portable electronic device 100 to execute the programmed functionality associated with that user interface element in the direct input mode. Rather, the touch input 156 in the relative gesture recognition mode will be processed as relative gesture input, irrespective of underlying graphical user interface elements 165, as described below.

In the relative gesture recognition mode, a gesture-based control module 140 within computer program 130 is configured to recognize a contact point 174 on touch screen sensor 162 between a digit of a user and the surface of touch screen sensor 162 in the defined region 170 in which the graphical user interface elements 168 are unselectable, and to present in the defined region 170 gesture control 172 proximate to contact point 174. The gesture-based control module 140 is further configured to identify a detected gesture 158 based on user touch input 156 originating from contact point 174, and to send a message to application program 110 to adjust an operation of portable electronic device 100 based on the detected gesture 158.

Computer program 130 may also be configured to enable gesture-based control module 140 to access developer specified control parameters 149 by which gesture control 172 is configured to operate. Developer specified control parameters 149 may be received by gesture-based control module 140 from developer specified control parameter interface 180. Developer specified control parameters 149 may be specified, for example, by an application program developer via a software development kit (SDK) and may include parameters to customize the features and the functionality of gesture control 172. For example, developer specified control parameters 149 may include a volume parameter, a playback speed parameter, a playback direction parameter, a control perimeter definition parameter, and a defined region definition parameter. In this manner, a developer may define the gesture control 172 to be a volume control or a playback control, and may specify the control perimeter or other geometric properties of the control, as well as the defined region of the display that will be configured to receive gesture input.

According to these developer specified control parameters, or alternatively according to other pre-defined parameters specified by computer program 130, in the relative gesture recognition mode, gesture-based control module 140 is configured to present gesture control 172 within defined region 170, which is configured to receive touch input 156. By identifying detected gesture 158 within defined region 170, gesture-based control module 140, in the relative gesture recognition mode, functions as a front-end processor to receive input that would otherwise, in the direct input mode, be directed to graphical user interface 164. Acting as a front end processor, it will be appreciated that the gesture-based control module 140 may be configured to position defined region 170 independent of the various elements displayed on graphical user interface 164 of portable electronic device 100, such that the defined region 170 floats over a portion of or the entire graphical user interface 164.

The relative gesture recognition mode may be initiated by receipt of mode switch user input 152 by input mode switch module 135 of computer program 130. Mode switch user input 152 is shown in FIG. 1 to be a touch input, which may be received via clutch key 154 associated with portable electronic device 100. Clutch key 154 may be a key, such as a switch or button, which is physically located on a housing of the portable electronic device 100 or may be located on an accessory, such as a pair of headphones that is in communication with the portable electronic device 100. The clutch key 154 may be a button or a capacitive switch, for example. Alternatively, mode switch user input 152 may be received via a contact between the digit of a user and the surface of the touch screen sensor 162, which contact may be a selection of an on-screen button, tapping, or gesture, for example.

Having received mode switch user input 152, input mode switch module 135 initiates the relative gesture recognition mode, and outputs a message to gesture-based control module 140. Specifically, input mode switch module 135 sends a request message to contact point recognizer 142 within gesture-based control module 140, indicating that the relative gesture recognition mode has been initiated and requesting that the contact point recognizer 142 return a contact point 174 in defined region 170, within which the graphical user interface elements 168 are unselectable.

Upon receiving the request message, contact point recognizer 142 recognizes contact point 174 within defined region 170 on the surface of touch screen sensor 162. Contact point 174 is formed by contact between a digit of a user (represented in FIG. 1 as touch input 156) and the surface of touch screen sensor 162 in defined region 170.

Upon recognition of contact point 174, contact point recognizer 142 may be configured to present a gesture control 172 having a defined perimeter 176 proximate to the recognized contact point 174 in defined region 170. Contact point recognizer 142 may receive input specifying parameters for control perimeter 176 from control perimeter definer 144. The contact point recognizer 142 may receive a control perimeter definition parameter from control perimeter definer 144. The control perimeter definition parameter may specify a formula, for example, for computing the control perimeter, which may be based on distance D from contact point 174. In one example, the control perimeter may be a preset control perimeter from a set of standard control definitions accessible via computer program 130. In another example, control perimeter definer 144 may receive input including a control perimeter definition parameter included in a set of developer specified control parameters 149 from developer specified parameter module 148, thus enabling a developer to specify the size and shape of the control perimeter.

It will be appreciated that gesture control 172 may include an associated icon, which may be partially translucent, although in other embodiments gesture control 172 may not be visually perceptible. The icon, if present, may visually indicate the control perimeter and/or the contact point, or may provide the user with other iconographic information. This other iconographic information may, for example, including an angle and degree of deflection in the case of a virtual control stick control, or degree of deflection in the case of a linear slider control. In some embodiments, the icons may respond to tapping inputs in addition to accepting gestures as described herein.

Having presented gesture control 172, contact point recognizer 142 is configured to send a message to identifier 146 requesting identification of detected gesture 158, which is illustrated as originating at contact point 174 in FIG. 1. Identifier 146 resides within gesture-based control module 140, and receives the message from contact point recognizer 142, as well as input from library 190 and developer specified parameter module 148.

Based on these inputs, identifier 146 is configured to identify touch input received via the touch sensor as a detected gesture 158 originating from contact point 174. For example, in FIG. 1, identifier 146 is shown receiving input from library 190, which is depicted to include definitions for pre-defined gestures 192. Thus, identifier 146 may identify detected gesture 158 based at least in part on an interpretation of detected gesture 158 that includes a comparison of detected gesture 158 received by gesture control 172 in defined region 170 in which graphical user interface elements 168 are unselectable via touch screen sensor 162 to a definition corresponding to one of a set of one or more pre-defined gestures 192 within library 190.

It will be appreciated that the interpretation of detected gesture 158 may be based on one or more developer specified control parameters 149, as included in developer specified parameter module 148 and received from developer specified control parameter interface 180. In this way, a developer for application program 110 may specify the interpretation of detected gesture 158. For example, a developer may indicate domains within defined region 170 in which detected gesture 158 may be ignored (e.g., a “dead zone”), discrimination parameters that interpret detected gesture 158 according to developer specified rules, logic configured to discriminate between actual detected gestures and spurious detected gestures, etc. In this way, a developer may tailor the operation of identifier 146 according to a particular application program 110.

Having interpreted detected gesture 158, identifier 146 sends a message to application program 110, via a communication module 150 of gesture-based control module. The message informs the application program 110 of the detected gesture 158, and may function to cause the application program to adjust an operation of portable electronic device 100 based on detected gesture 158.

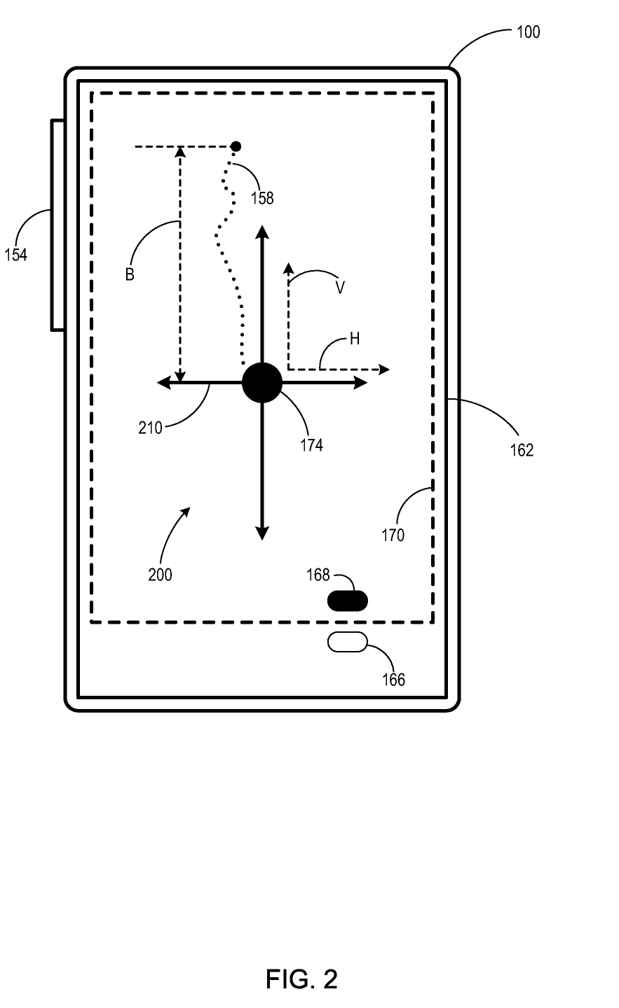

For example, the identifier 146 may be configured instruct the application program 110 to adjust an operation of portable electronic device 100 based on a relative distance from contact point 174 to detected gesture 158 that has been identified. One example of this is illustrated in FIG. 2, in which gesture-based control module 140 of computer program 130 is configured to send a message to a media playback application program to adjust the operation of portable electronic device 100 according to detected gesture 158 as identified by gesture-based control module 140. Axis V represents a vertical direction that is orthogonal to axis H, which represents a horizontal direction.

Continuing with FIG. 2, gesture control 172 (FIG. 1) is presented as a transport control 200 in defined region 170 within touch screen sensor 162 of portable electronic device 100. Clutch key 154, here illustrated on an edge of portable electronic device 100, may be actuated to initiate the relative gesture recognition mode. Upon receipt of a finger touch within defined region 170, contact point recognizer 142 presents transport control 200. Transport control 200 is configured to snap a frame of reference 210 for transport control 200 to contact point 174 within defined region 170. In this example, which represents a playback control mode of transport control 200, detected gesture 158 is identified by identifier 146 based on detection of a substantially vertical direction of the digit of the user relative to frame of reference 210, and in response communication module 150 sends a message from the identifier 146 to application program 110, to adjust a volume of the media playback.

The substantially positive vertical direction of detected gesture 158 may be interpreted as corresponding to a pre-defined gesture 192 within library 190 for increasing the volume of media playback. Further, a volume intensity of the media playback may be determined according to distance B shown, which illustrates the distance between contact point 174 and an endpoint of detected gesture 158. For example, the volume intensity may be determined by an absolute measure of distance B. Thus, if B is determined to be five measured distance units, the volume intensity may be changed by five volume units, for example. In another example, the volume intensity may be determined by distance B relative to a particular volume level which may be specified among a set of developer specified control parameters 149 (FIG. 1) specified by a developer for application program 110. Thus, if B is determined to be five measured distance units, the volume intensity may be changed by five percent of a pre-defined volume level, for example. In an alternative example, if distance B is determined to be five percent of a distance corresponding to a control perimeter definition perimeter (not shown), the volume intensity may be changed by a corresponding five percent.

To implement a pause control, for example, the detected gesture 158 may be identified based on detection of a tapping movement of the digit of the user relative to the frame of reference 210. In response, the gesture based control module may send the tapping input to the application program, which may be interpret the tapping input to change a pause status of media playback. To implement fast forward and/or rewind controls, the detected gesture 158 may be identified based on detection of a substantially horizontal direction of movement of the digit of a user relative to frame of reference 210, and in response the gesture based control module may send the detected gesture 158 to the application program, which in turn may adjust a temporal position of a media playback. It will be appreciated that media playback may be audio or visual media stored on portable electronic device 100 or may be media received by portable electronic device 100 from a network. Further, transport control 200 may be configured according to the type of media played back. For example, if the media playback is a broadcast stream from a radio station, the fast forward and/or rewind controls described above may instead control scanning forward or backward across radio frequencies, the above-described tapping input may activate a station preset, etc.

It will be further appreciated that transport control 200 may further present control options according to the context of an application program, which may be gesture based or non-gesture based, in addition to the gesture based transport controls. For example, if transport control 200 is presented in the context of a web browser application program, controls relevant to the web browser may be presented in addition to transport controls for controlling media playback. In another example, if transport control 200 is presented in the context of a computer game application program, controls relevant to the computer game may be presented, for example, transport controls controlling game music and a gesture based menu for pausing the game and selecting game options. In this way, a developer may be able to harmonize transport control 200 to an application program.

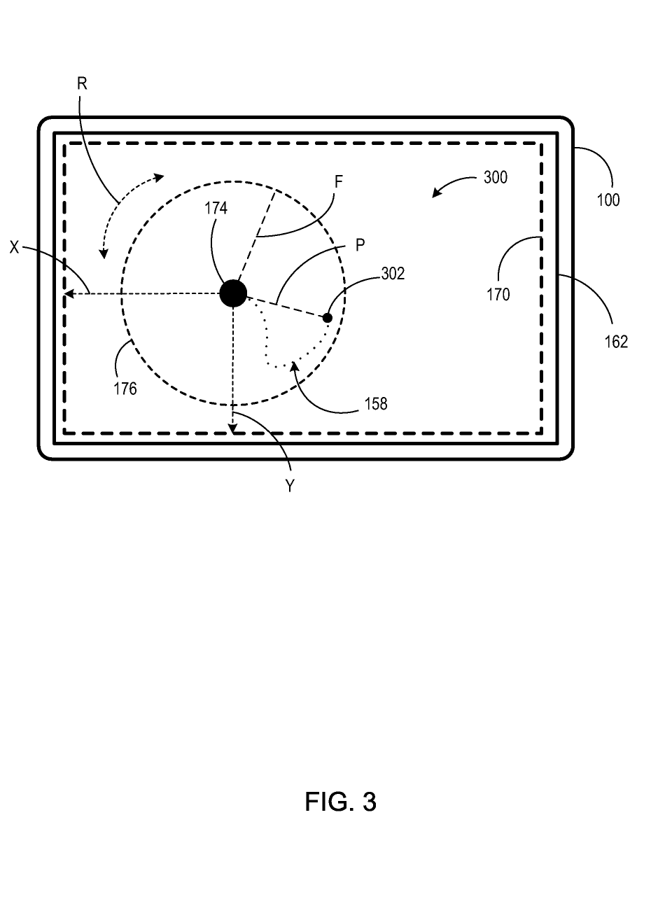

In addition, the gesture based control module may be configured to instruct the application program to adjust an operation of portable electronic device 100 based on a relative distance from a pre-determined location 178 on defined control perimeter 176 to the detected gesture 158. For example, as shown in FIG. 3 the computer program may be a computer game application program, and the gesture-based control module 140 of computer program 130 may be configured to send a message to the computer game application program to adjust the operation of portable electronic device 100 based on a relative distance of a virtual control stick control 302 from control perimeter 176 or contact point 174. It will be appreciated that in FIG. 3, axis Y represents a vertical direction that is orthogonal to axis X, which represents a horizontal direction. An additional reference R represents a rotational direction about a rotational axis normal to the plane XY, wherein plane XY is parallel to the surface of touch screen sensor 162. In this example, the rotational axis intersects plane XY at contact point 174. It will be appreciated that the

Continuing with FIG. 3, gesture control 172 (FIG. 1) is presented as virtual game control 300. Virtual game control 300 is configured to spawn the virtual control stick control 302 at contact point 174 upon receipt of a touch input within defined region 170 in the relative gesture recognition mode. The process of spawning virtual control stick control 302 will be appreciated as creating an instance of virtual control stick control 302 at contact point 174. Gesture-based control module 140 is further configured to define control perimeter 176 surrounding virtual game control stick control 302 in defined region 170 within touch screen sensor 162 of portable electronic device 100. Gesture-based control module 140 may be further configured to define full-scale deflection F of virtual control stick control 302 at control perimeter 176. Further, the message sent to the computer game application program when detected gesture 158, based on user touch input 156 (FIG. 1) received by virtual game control 300 via the virtual control stick control 302 is within control perimeter 176, is in proportion to measured deflection P of virtual control stick control 302 with respect to full-scale deflection F of virtual control stick control 302. Further still, the message sent to the computer game application program when detected gesture 158 based on user touch input 156 received by virtual game control 300 via virtual control stick control 302 is received outside of control perimeter 176, is substantially the same as full-scale deflection F of virtual control stick control 302.

The example shown in FIG. 3, which represents a computer game control mode of virtual game control 300, depicts virtual control stick control 302 at a distance P from contact point 174 within control perimeter 176. In such an example, detected gesture 158 is identified by identifier 146 (FIG. 1) based on detected contact between a digit of a user and the surface of touch screen sensor 162 at contact point 174. In response, communication module 150 sends a message to application program 110 to adjust the operation of portable electronic device 100 based on a proportion of distance P and full-scale deflection F of virtual control stick control 302. For example, if the proportional response is a linear proportion, and measured distance P represented 80 percent of full-scale deflection F, communication module 150 would send a message to application program 110 to adjust the output of portable electronic device 100 by 80 percent of an operation parameter. In the context of a computer game application program, the operation parameter might be a speed of travel, though it will be appreciated that other operation parameters may be adjusted similarly. For example, the relative position of virtual control stick control 302 within defined region 170 with respect to contact point 174 may provide a directional operation parameter. Specifically, a movement of virtual control stick control 302 along the path described by detected gesture 158 may be interpreted and output as a travel path for a game character, a direction of a rotational movement (such as a character or point-of-view swivel), etc. It will further be appreciated that these examples of operation parameters and the method of proportioning the output associated with them may be specified among a set of developer specified control parameters 149 (FIG. 1) specified by a developer for application program 110. In this way, gesture-based control module 140 may send a message to application program 110 to adjust the operation of portable electronic device 100.

In the various embodiments described above, it will be appreciated that when the contact point recognizer detects that contact between a digit of the user and the touch pad sensor has been terminated, for example, for a predetermined period of time, the gesture based control mode module 140 ceases identifying the gesture via identifier 146 and begins attempting to detect touch. When a new contact point 174 is detected, it will be appreciated that a new gesture control 172 will be instantiated and as a result the frame of reference 210 will effectively snap to the location of the new contact point 174. In this manner, wherever the user chooses to contact the touch screen sensor 162 within defined region 170, a gesture control will be spawned in that location, thus enabling user input at various locations on the display 160. With such flexible input, the user can easily control portable electronic device 100 without visually examining the display 160, and without unintentionally activating unselectable graphical user interface elements.

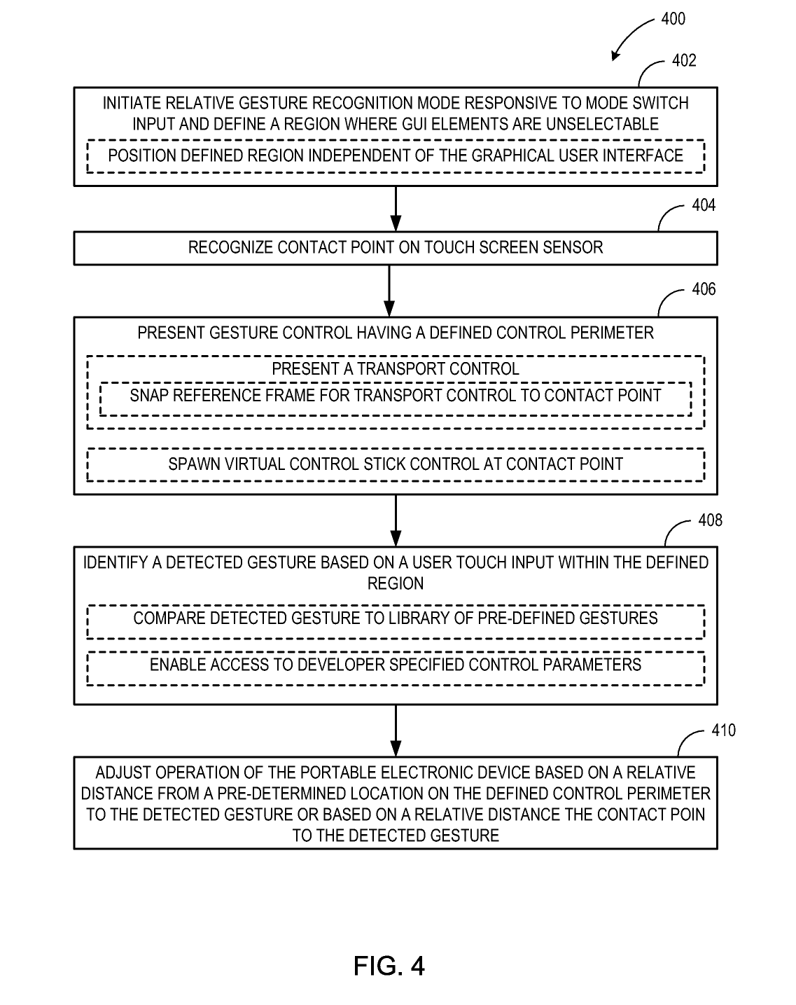

FIG. 4 shows a flowchart depicting an embodiment of a method 400 of controlling a portable electronic device having a touch screen sensor. Method 400 may be implemented by any suitable portable electronic device having a touch screen sensor, including the portable electronic device 100 of FIGS. 1-3.

Method 400 includes, at 402, initiating a relative gesture recognition mode responsive to a mode switch user input, wherein in the relative gesture recognition mode one or more graphical user interface elements in a defined region of a graphical user interface are made to be unselectable. The mode switch user input may be selected from the group consisting of a user input via a clutch key associated with the portable electronic device and a user input via a contact between the digit of a user and the surface of the touch screen sensor. In some examples, initiating a relative gesture at 402 may further include positioning the defined region of the graphical user interface in which the graphical user interface elements are unselectable independent of the graphical user interface. In other words, once the relative gesture recognition mode is activated, the defined region may be positioned anywhere on the touch screen sensor, and may include a subregion of the touch screen sensor or the entire touch screen sensor.

Method 400 further includes, at 404, recognizing a contact point on the touch screen sensor between a digit of a user and a surface of the touch screen sensor in the defined region in which the graphical user interface elements are unselectable in the relative gesture recognition mode. Next, method 400 includes, at 406, presenting a gesture control having a defined control perimeter proximate to the contact point in the defined region in which the graphical user interface elements are unselectable in the relative gesture recognition mode.

It will be appreciated that presenting a gesture control at 406 may include presenting a transport control, as described above. In addition, presenting a gesture control may further include snapping a frame of reference for the transport control to the contact point within the defined region. Further, presenting a gesture control having a defined control perimeter proximate to the contact point may include spawning a virtual control stick control for a virtual game control at the contact point, wherein the defined control perimeter has a full-scale deflection of a virtual control stick control at the defined control perimeter. With the device in the relative gesture recognition mode and with the gesture control presented in this manner, a detected gesture may be received within the defined region of the touch screen sensor, and identified.

Method 400 further includes, at 408, identifying a detected gesture based on a user touch input originating from the contact point received by the gesture control in the defined region in which the graphical user interface elements are unselectable within the touch screen sensor via the touch screen sensor. In one example, identifying a detected gesture further includes interpreting the detected gesture based at least in part on a comparison of the detected gesture received by the gesture control in the defined region in which the graphical user interface elements are unselectable via the touch screen sensor to a definition corresponding to one of a set of one or more pre-defined gestures within the a library of pre-defined gestures.

Method 400 may further include, at 408, enabling the gesture-based control module to access developer specified control parameters by which the gesture control is configured to operate. In one example, the developer specified control parameters may be selected from the group consisting of a volume parameter, a playback speed parameter, a playback direction parameter, a control perimeter definition parameter, and a defined region definition parameter. In this way, a developer may specify, via a software development kit, for example, control parameters for the portable electronic device that are peculiar to a particular application program.

Finally, method 400 further includes, at 410 adjusting an operation of the portable electronic device based on a relative distance from a pre-determined location on the defined control perimeter to the detected gesture so identified or based on a relative distance from the contact point to the detected gesture so identified. In one example, adjusting the operation of the portable electronic device includes adjusting a temporal position of a media playback responsive to the detected gesture identified by a substantially horizontal direction of the digit of a user relative to the frame of reference. In another example, adjusting the operation of the device includes adjusting a volume of the media playback responsive to responsive to the detected gesture identified by a substantially vertical direction of the digit of a user relative to the frame of reference. In yet another example, adjusting the operation of the device includes adjusting a pause status of the media playback responsive to the detected gesture identified by a tapping movement of the digit of a user relative to the frame of reference.

In addition, adjusting an operation of the portable electronic device may include outputting a response from the virtual game control that is in proportion to a measured deflection of the virtual control stick control with respect to the full-scale deflection of the virtual control stick control, when the gesture received by the touch screen sensor is received within the defined control perimeter. And, adjusting an operation of the portable electronic device may further include outputting a response from the virtual game control that is substantially the same as a full-scale deflection of the virtual control stick, when the relative gesture is received outside of the defined control perimeter.

The above described method, like the systems described herein, may be used to facilitate user control of a portable electronic device in situations in which the user does not visually examine the device, and without unintentional selection of graphical user interface elements that have been made unselectable.

It will be appreciated that the method illustrated in FIG. 4 may reside on a computer-readable storage medium comprising instructions executable by a computing device to perform said method. It will further be appreciated that the computing devices described herein may be any suitable computing device configured to execute the programs described herein. For example, the computing devices may be a mainframe computer, personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A computer program executable on a portable electronic device having a touch screen sensor, the computer program comprising:
an input mode switching module configured to receive a mode switch user input to switch between a direct input mode and a relative gesture recognition mode in response to a user input, wherein in the direct input mode, one or more graphical user interface elements of a graphical user interface of the portable electronic device are selectable via touch input of the user, and wherein in the relative gesture recognition mode, the graphical user interface elements in at least a defined region of the graphical user interface are made to be unselectable; and
a gesture-based control module configured, in the relative gesture recognition mode, to recognize a contact point on the touch screen sensor between a digit of a user and a surface of the touch screen sensor in the defined region in which the graphical user interface elements are unselectable, and to present in the defined region a gesture control proximate to the contact point, the gesture-based control module being further configured to identify a detected gesture based on user touch input originating from the contact point, and to send a message to an application program to adjust an operation of the portable electronic device based on the detected gesture.

2. The computer program of claim 1, wherein the mode switch user input is selected from the group consisting of a user input via a clutch key associated with the portable electronic device and a user input via a contact between the digit of a user and the surface of the touch screen sensor.

3. The computer program of claim 1, wherein the gesture control includes a transport control configured to snap a frame of reference for the transport control to the contact point within the defined region.

4. The computer program of claim 3,
wherein the gesture-based control module is configured to send a message to a media playback application program to adjust the operation of the portable electronic device according to the detected gesture identified by the gesture-based control module;
wherein in a playback control mode of the transport control, the detected gesture is identified based on detection of a substantially horizontal direction of movement of the digit of a user relative to the frame of reference, and in response adjusts a temporal position of a media playback;
wherein in a volume control mode of the transport control, the detected gesture is identified based on detection of a substantially vertical direction of the digit of the user relative to the frame of reference, and in response adjusts a volume of the media playback; and
wherein in a pause control mode of the transport control, the detected gesture is identified based detection of a tapping movement of the digit of the user relative to the frame of reference, and in response changes a pause status of the media playback.

5. The computer program of claim 1,
wherein the gesture control includes a virtual game control configured to spawn a virtual control stick control for the virtual game control at the contact point;
wherein the gesture-based control module is further configured to define a control perimeter surrounding the virtual game control stick;
wherein the gesture-based control module is further configured to send a message to a computer game application program to adjust the operation of the portable electronic device based on a relative distance of the virtual control stick control from the control perimeter or the contact point.

6. The computer program of claim 5,
wherein the gesture-based control module is further configured to define a full-scale deflection of the virtual control stick control at the control perimeter;
wherein the message sent to the computer game application program when the detected gesture based on the user touch input received by the virtual game control via the virtual control stick control is within the control perimeter is in proportion to a measured deflection of the virtual control stick control with respect to the full-scale deflection of the virtual control stick control; and
wherein the message sent to the computer game application program when the detected gesture based on the user touch input received by the virtual game control via the virtual control stick control is received outside of the control perimeter is substantially the same as a full-scale deflection of the virtual control stick control.

7. The computer program of claim 1, the gesture-based control module further configured to position the defined region independent of the graphical user interface of the portable electronic device.

8. The computer program of claim 1, further configured to enable the gesture-based control module to access developer specified control parameters by which the gesture control is configured to operate.

9. The computer program of claim 8, wherein the developer specified control parameters are selected from the group consisting of a volume parameter, a playback speed parameter, a playback direction parameter, a control perimeter definition parameter, and a defined region definition parameter.

10. A method of controlling a portable electronic device having a touch screen sensor, comprising:
initiating a relative gesture recognition mode responsive to a mode-switch user input, wherein in the relative gesture recognition mode one or more graphical user interface elements in a defined region of a graphical user interface are made to be unselectable;
recognizing a contact point on the touch screen sensor between a digit of a user and a surface of the touch screen sensor in the defined region in which the graphical user interface elements are unselectable in the relative gesture recognition mode;
presenting a gesture control having a defined control perimeter proximate to the contact point in the defined region in which the graphical user interface elements are unselectable in the relative gesture recognition mode;
identifying a detected gesture based on a user touch input originating from the contact point received by the gesture control in the defined region in which the graphical user interface elements are unselectable within the touch screen sensor via the touch screen sensor; and
adjusting an operation of the portable electronic device based on a relative distance from a pre-determined location on the defined control perimeter to the detected gesture or based on a relative distance from the contact point to the detected gesture.

11. The method of claim 10, wherein the mode switch user input is selected from the group consisting of a user input via a clutch key associated with the portable electronic device and a user input via a contact between the digit of a user and the surface of the touch screen sensor.

12. The method of claim 10,
wherein presenting a gesture control includes presenting a transport control;
wherein presenting a gesture control further includes snapping a frame of reference for the transport control to the contact point within the defined region.

13. The method of claim 12, wherein adjusting an operation of the portable electronic device includes:
adjusting a temporal position of a media playback responsive to the detected gesture identified by a substantially horizontal direction of the digit of a user relative to the frame of reference;
adjusting a volume of a media playback responsive to responsive to the detected gesture identified by a substantially vertical direction of the digit of a user relative to the frame of reference; and
adjusting a pause status of a media playback responsive to the detected gesture identified by a tapping movement of the digit of a user relative to the frame of reference.

14. The method of claim 10, wherein presenting a gesture control having a defined control perimeter proximate to the contact point includes spawning a virtual control stick control for a virtual game control at the contact point, and wherein the defined control perimeter has a full-scale deflection of a virtual control stick control at the defined control perimeter.

15. The method of claim 14, wherein adjusting an operation of the portable electronic device includes:
outputting a response from the virtual game control that is in proportion to a measured deflection of the virtual control stick control with respect to the full-scale deflection of the virtual control stick control, when the gesture received by the touch screen sensor is received within the defined control perimeter; and
outputting a response from the virtual game control that is substantially the same as a full-scale deflection of the virtual control stick control, when the relative gesture is received outside of the defined control perimeter.

16. The method of claim 10, further comprising positioning the defined region of the graphical user interface in which the graphical user interface elements are unselectable independent of the graphical user interface.

17. The method of claim 10, further comprising enabling the gesture-based control module to access developer specified control parameters by which the gesture control is configured to operate.

18. The method of claim 17, wherein the developer specified control parameters are selected from the group consisting of a volume parameter, a playback speed parameter, a playback direction parameter, a control perimeter definition parameter, and a defined region definition parameter.

19. The method of claim 10, identifying a detected gesture including interpreting the detected gesture based at least in part on a comparison of the detected gesture received by the gesture control in the defined region in which the graphical user interface elements are unselectable via the touch screen sensor to a definition corresponding to one of a set of one or more pre-defined gestures within a library of pre-defined gestures.

20. A computer-readable storage medium comprising instructions executable by a computing device to perform a method comprising:
initiating a relative gesture recognition mode responsive to a mode-switch user input, wherein in the relative gesture recognition mode one or more graphical user interface elements in a defined region of a graphical user interface are made to be unselectable;
recognizing a contact point on the touch screen sensor between a digit of a user and a surface of the touch screen sensor in the defined region in which the graphical user interface elements are unselectable in the relative gesture recognition mode;
presenting a gesture control having a defined control perimeter proximate to the contact point in the defined region in which the graphical user interface elements are unselectable in the relative gesture recognition mode;
identifying a detected gesture based on a user touch input originating from the contact point received by the gesture control in the defined region in which the graphical user interface elements are unselectable within the touch screen sensor via the touch screen sensor; and
adjusting an operation of the portable electronic device based on a relative distance from a pre-determined location on the defined control perimeter to the detected gesture or based on a relative distance from the contact point to the detected gesture.
